(19) United States
(12) Patent Application Publication
(10) Pub. No.: US 2008/0155564 A1
(43) Pub. Date: Jun. 26, 2008

(54) EVENT CORRELATION BASED TROUBLE TICKET RESOLUTION SYSTEM INCORPORATING ADAPTIVE RULES OPTIMIZATION

(75) Inventors: Vladimir Shcherbina, Nesher (IL); Eugeniusz Walach, Haifa (IL)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/948,532

(22) Filed: Nov. 30, 2007

(30) Foreign Application Priority Data
Dec. 1, 2006 (GB) 0624024.6

(51) Int. Cl. G06F 9/44; G06F 15/18; G06F 17/30

(52) U.S. Cl. 719/318; 707/5; 706/14; 707/E17.014

(57) ABSTRACT

A system and method for event correlation and adaptive rules optimization in the context of a trouble ticket resolution system. The adaptive rules optimizer incorporates learning principles that achieve a high degree of automation while leaving control in the hands of an operator. To mitigate the effects of possible errors, the adaptive rules optimizer switches from hard decisions to soft decisions. The tickets in the queue and their related events are prioritized to mimic the best practices introduced by the support team handling the given problem, to take into account the business impact so that at each point in time the operator's work provides maximum overall benefit and to provide all auxiliary information that may be instrumental in the problem resolution process.

### FIELD OF THE INVENTION

The present invention relates to the field of adaptive optimization and more particularly relates to an event correlation based trouble ticket resolution system incorporating adaptive rules optimization.

### BACKGROUND OF THE INVENTION

Trouble ticket resolution systems are well known in the art. It has been estimated that over 50% of the costs associated with global delivery factories are due to costs associated with personnel devoted solely to problem resolution. In order to reduce these costs and to raise the server/personnel ratio it is imperative to increase the productivity of the problem resolution process.

Currently, industry invests heavily in the development of problem resolution tools. In general, the problem resolution tools take one of two approaches: either a rules based approach or a code-book approach. The rules based approach relies on a set of hard coded rules that filter out irrelevant events. Several disadvantages of rules based tools are (1) they hinge on manual updates of the rules, which tend to be laborious and costly; (2) the rule sets are difficult to test and debug: and (3) in practice the rule sets tend to be simple and relatively weak.

The code-book approach relies on the predefined knowledge of the system configuration. Based on such knowledge, the system can determine the route cause of the failure and eliminate spurious events. Several disadvantages of the code-book based tools are (1) they require manual updates of the configuration information (this difficulty can be mitigated if automated configuration learning tools are applied); and (2) systems built using this approach are very difficult to debug and control.

Both these prior art approaches have disadvantages in that both approaches rely on hard decisions. Thus, mistakes in the rules are very difficult to notice and correct. In addition, neither of the approaches addresses the issue of optimizing operator productivity. Operator productivity denotes the time to resolve a problem once all the spurious tickets have been filtered out.

There is thus a need for a problem resolution tool that optimizes operator productivity and that does not rely on hard decisions.

### SUMMARY OF THE INVENTION

The present invention is a system and method for event correlation and adaptive rules optimization. An assumption of the invention is that human experts that actually handle problem resolution are the best source of the system knowledge. Accordingly, the adaptive rules optimizer starts from the present manual operation. The system functions to monitor actions taken by the operators. The operator's actions (which are considered expert actions by the invention) are used in order to provide adaptive optimization of the system response. Further, the invention provides a queue prioritization method that uses a combined approach based on the analysis of the response time while disregarding the differences in the relative impact of different events.

If a ticket is closed without any action being taken then similar future events may be assigned lower priority. The system logs the features of spurious events and correlates them with other tickets raised the same time. If the ticket resolution is given high priority (i.e. the operator has chosen certain events from all the tickets waiting in the queue), similar future events may be assigned higher priority. The system logs the features of high priority events and all the vents that disappear automatically once a given ticket is closed.

Every time a ticket is closed, the system automatically re-computes priorities of all the remaining tickets. In such a manner, the system automatically learns the spurious tickets that need to be filtered out. Moreover, it also optimizes the sequencing of all the tickets that require manual attention.

If the configuration changes (e.g., certain servers are switches from one communication network to another communication network), the system learns this fact automatically by logging the changed pattern of alarms and adjusted reaction of system administrators.

The invention is described in the context of a trouble ticket resolution system. The adaptive rules optimizer incorporates learning principles that achieve a high degree of automation while leaving control in the hands of an operator. To mitigate the effects of possible errors, the adaptive rules optimizer switches from hard decisions to soft decisions. The tickets in the queue and their related events are prioritized to mimic the best practices introduced by the support team handling the given problem, to take into account the business impact so that at each point in time the operator's work provides maximum overall benefit and to provide all auxiliary information that may be instrumental in the problem resolution process.

There is therefore provided in accordance with the invention, an event correlation tool for use in a trouble ticket resolution system, the method comprising the steps of an action log monitor operative to classify tickets received in a ticket queue, log features of spurious events associated therewith and correlate the events with other tickets received at substantially the same time and a prioritization engine in communication with the action log monitor, the prioritization engine operative to assign priorities to the received tickets in accordance with previous operator action on the ticket queue.

There is also provided in accordance with the invention, a problem resolution system comprising a ticket queue for receiving and holding trouble tickets, an operator console adapted to permit an operator to interact with and perform action on tickets held in the ticket queue, a ticket log for storing features of spurious events an actions taken on tickets in the queue, an action log monitor in communication with the operator console and the ticket log, the action log monitor operative to classify tickets in the ticket queue, log features of spurious events associated therewith and correlate the events with other tickets received at substantially the same time and a prioritization engine in communication with the action log monitor and the ticket queue, the prioritization engine operative to assign priorities to tickets in the ticket queue in accordance with previous operator action on the ticket queue as captured by the action log monitor.

There is further provided in accordance with the invention, an event correlation method for use in a trouble ticket resolution system, the method comprising the steps of assigning a prioritization to tickets in a ticket queue in accordance with historical actions taken by an operator, retrieving tickets from the queue in accordance with the assigned prioritizations, recognizing a ticket type for each retrieved ticket, performing an appropriate action for each particular ticket type and discarding spurious events associated with the particular ticket type.

There is also provided in accordance with the invention, an adaptive rules optimization method for use in a trouble ticket resolution tool adapted to store received trouble tickets in a ticket queue, the method comprising the steps of retrieving a ticket from the ticket queue, saving a ticket resolution and a set of related alerts existing at that time in a ticket/alert database, performing a fuzzy search on past alerts stored in the ticket/alert database to find a closest match with alerts associated with the retrieved ticket and directing the resolution tool to only consider those actions taken for the state corresponding to the closest matching set of alerts.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the adaptive rules optimizer system of the present invention;

FIG. 2 is a general block diagram illustrating the automatic trouble ticket queuing system application of the adaptive rules optimizer of the present invention;

FIG. 3 is a block diagram illustrating the online mode of the automatic trouble ticket queuing system of the present invention;

FIG. 4 is a block diagram illustrating the offline mode of the automatic trouble ticket queuing system of the present invention;

FIG. 5 is a block diagram illustrating the action log monitor portion of the automatic trouble ticket queuing system of the present invention in more detail;

FIG. 6 is a block diagram illustrating the prioritization engine portion of the automatic trouble ticket queuing system of the present invention in more detail;

FIG. 7 is a block diagram illustrating the post-processor analyzer portion of the automatic trouble ticket queuing system of the present invention in more detail;

FIG. 8 is a flow diagram illustrating the learning mode of the automatic trouble ticket queuing system of the present invention;

FIG. 9 is a flow diagram illustrating the production mode of the automatic trouble ticket queuing system of the present invention; and

FIG. 10 is a flow diagram illustrating the ticket sequencing of the automatic trouble ticket queuing system of the present invention.

### DETAILED DESCRIPTION OF THE INVENTION

The present invention is a system and method for event correlation and adaptive rules optimization. To illustrate the principles of the present invention, the invention is described in the context of a trouble ticket resolution system. Note that it is not intended to limit the scope of the invention as the adaptive rules optimizer can be applied to other systems as well without departing from the spirit and scope of the invention.

The adaptive rules optimizer incorporates learning principles that achieve a high degree of automation while leaving control in the hands of an operator. To mitigate the effects of possible errors, the adaptive rules optimizer switches from hard decisions to soft decisions. The tickets in the queue and their related events are prioritized to mimic the best practices introduced by the support team handling the given problem, to take into account the business impact so that at each point in time the operator's work provides maximum overall benefit and to provide all auxiliary information that may be instrumental in the problem resolution process.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be borne in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

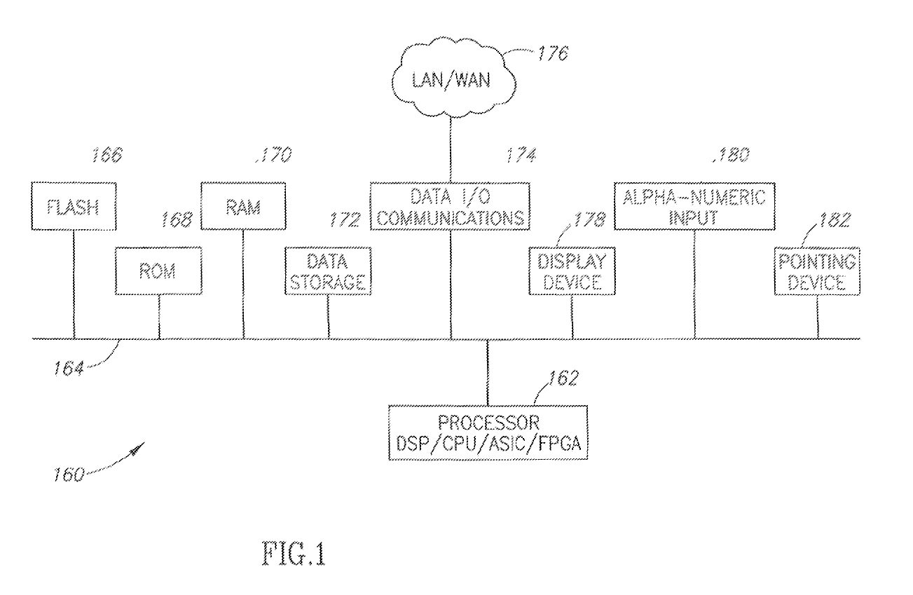

A block diagram illustrating an example computer processing system adapted to implement the adaptive rules optimization based automatic trouble ticket queuing system of the present invention is shown in FIG. 1. The computer system, generally referenced 160, comprises a processor 162 which may comprise a digital signal processor (DSP), central processing unit (CPU), microcontroller, microprocessor, microcomputer, ASIC or FPGA core. The system also comprises static read only memory 168 and dynamic main memory 170 all in communication with the processor. The processor is also in communication, via bus 164, with a number of peripheral devices that are also included in the computer system. Peripheral devices coupled to the bus include a display device 178 (e.g., monitor), alpha-numeric input device 180 (e.g., keyboard) and pointing device 182 (e.g., mouse, tablet, etc.)

The computer system is connected to one or more external networks such as a LAN or WAN 176 via communication lines connected to the system via data I/O communications interface 174 (e.g., network interface card or NIC). The network adapters 174 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 172 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the adaptive rules optimization system is adapted to reside on a computer readable medium, such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the method of this invention. The software adapted to implement the adaptive rules optimization system of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the adaptive rules optimization system of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

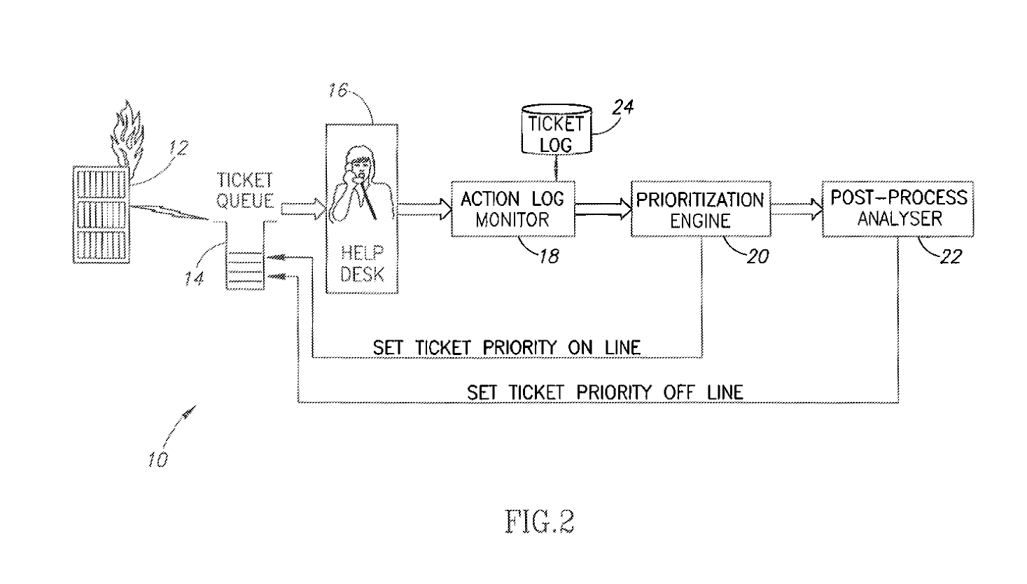

A general block diagram illustrating the automatic trouble ticket queuing system application of the adaptive rules optimizer of the present invention is shown in FIG. 2. The system, generally referenced 10, comprises a ticket queue 14, action log monitor 18, tickets log 24, prioritization engine 20 and post-process analyzer 22.

In operation, the help desk 16 opens trouble tickets and/or receives automatically generated trouble tickets in response to events that occur in the system. For example, a communications link failure or equipment failure 12 would cause one or more trouble tickets to be generated. The action log monitor logs the actions taken by the operational team (operator, support staff, etc.). The prioritization engine computes optimal sequencing for given tickets and the post-process analyzer facilitates post-factum analysis. The operation of each of these components is described in more detail infra.

An assumption of the event correlation and adaptive rules optimization invention is that human experts that actually handle problem resolution are the best source of the system knowledge. Accordingly, the adaptive rules optimizer based trouble ticket system 10 starts from the present manual operation. The system functions to monitor actions taken by the operators. The operator's actions (which are considered expert actions by the invention) are used in order to provide adaptive optimization of the system response. Further, the invention provides a queue prioritization method that uses a combined approach based on the analysis of the response time while disregarding the differences in the relative impact of different events.

If a ticket is closed without any action being taken then similar future events may be assigned lower priority. The system logs the features of spurious events and correlates them with other tickets raised the same time. If the ticket resolution is given high priority (i.e. the operator has chosen certain events from all the tickets waiting in the queue), similar future events may be assigned higher priority. The system logs the features of high priority events and all the events that disappear automatically once a given ticket is closed.

Every time a ticket is closed, the system automatically re-computes priorities of all the remaining tickets. In such a manner, the system automatically learns the spurious tickets that need to be filtered out. Moreover, it also optimizes the sequencing of all the tickets that require manual attention.

If the configuration changes (e.g., certain servers are switches from one communication network to another communication network), the system learns this fact automatically by logging the changed pattern of alarms and adjusted reaction of system administrators.

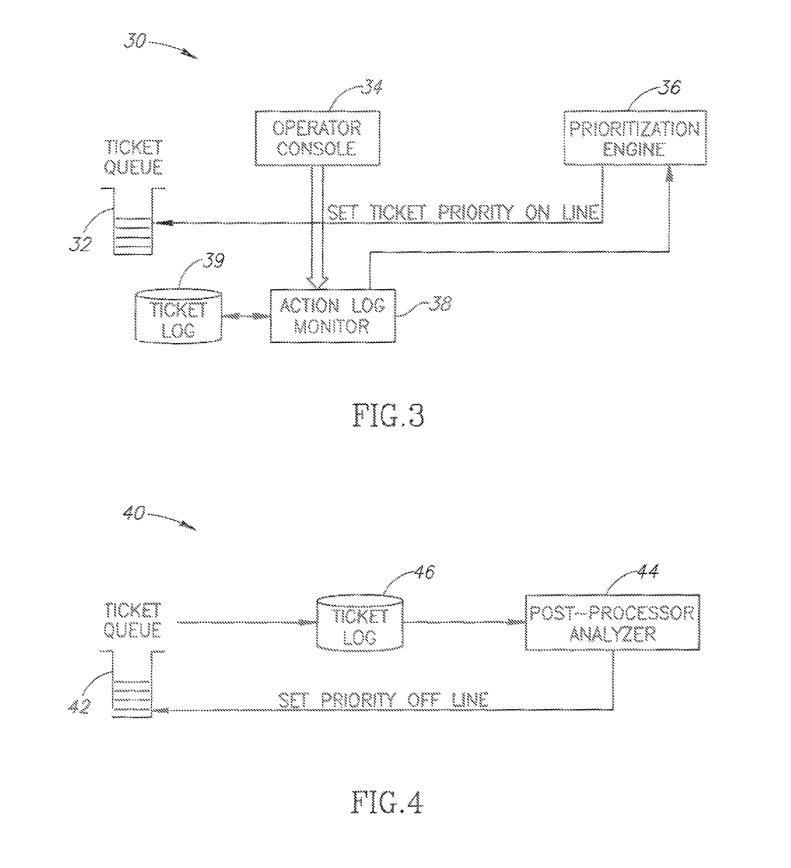

A block diagram illustrating the online mode of the automatic trouble ticket queuing system of the present invention is shown in FIG. 3. The system in online mode of operation, generally referenced 30, comprises a ticket queue 32, operator console 34, ticket log 39, action log monitor 38 and prioritization engine 36. The post-processor analyzer of FIG. 2 is not required for the online mode of operation. The priorities assigned to the tickets in the ticket queue are adjusted in accordance with the priorities generated by the prioritization engine. A key aspect of the invention is that the expert actions of the operative are taken into consideration in addition to correlating present events (i.e. alarms) with historical data.

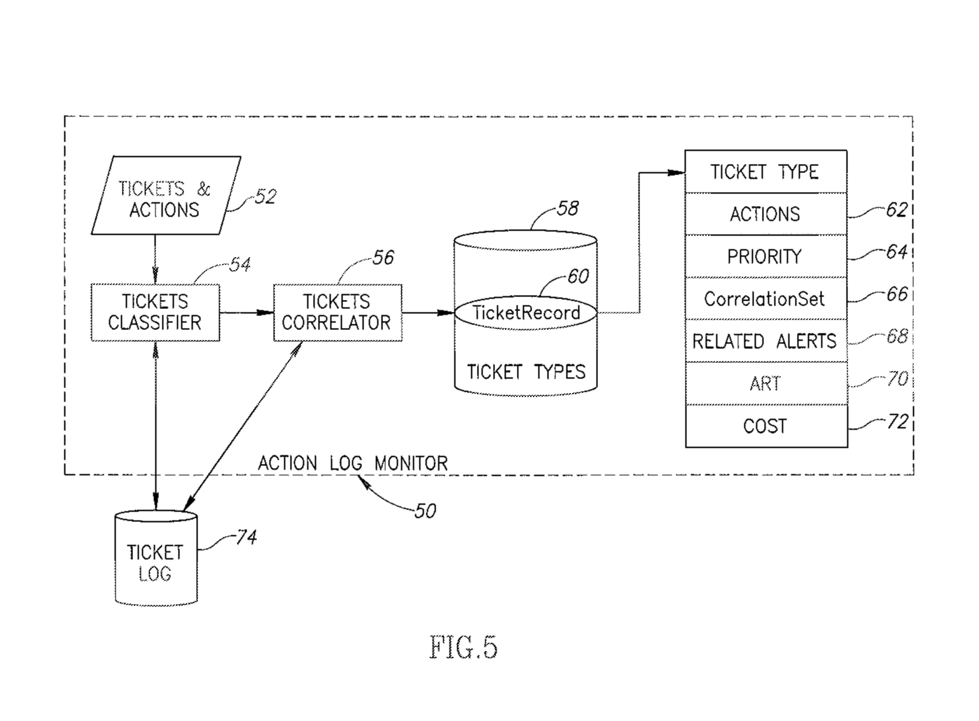

A block diagram illustrating the offline mode of the automatic trouble ticket queuing system of the present invention is shown in FIG. 4. The system in offline mode of operation, generally referenced 40, comprises a ticket queue 42, ticket log 46 and post-processor analyzer 44. In this mode of operation, the post-processor analyzer 44 rather than the prioritization engine of FIG. 3 determines and assigns priorities to the ticket in the ticket queue.

FIG. 3 shows trouble tickets generated by the system being accumulated in the ticket queue 32. The online mode itself can be in either one of two sub-modes of operation: learning and production. In the learning mode, the operator (via the operator console 34) selects tickets from the ticket queue in accordance with their priority and performs certain actions to resolve the tickets based on her/his experience (i.e. expert actions). The action log monitor 38 functions to classify the type of each ticket; log the features of spurious events and correlate these spurious events with those of other tickets generated around substantially the same time, log these related actions and associate them with the particular ticket type.

If the operator closes a ticket without any action being taken, then the prioritization engine 36 is operative to assign a lower priority for future events associated with tickets of that ticket type. Accordingly, the system logs the features of spurious events and correlates them with those of other tickets raised around substantially the same time. If the operator has chosen certain trouble tickets from all the trouble tickets waiting in his queue, then the prioritization engine 36 assigns a higher priority for future tickets of that ticket type.

Accordingly, the action log monitor 38 functions to log the features of high priority tickets and all associated events that disappear automatically once a given trouble ticket is closed. Every time a trouble ticket is closed, the prioritization engine 36 automatically re-computes the priorities for all the trouble tickets remaining in the ticket queue. In such a manner, the prioritization engine automatically learns the spurious tickets that should be filtered out since they are ancillary to the root cause of the problem.

It should be noted that both learning and utilization (i.e. operation) of the system is state based. In other words, during the training stage, how each ticket is resolved is saved together with the set of alerts that existed at that particular time. The set of alerts comprise the state existing at that time.

Then, during the operational stage, the existing state (i.e. set of alerts) is compared to states that have been encountered in the past. A fuzzy search is performed so as to select a closest match. The system then automatically takes into account only those manual actions that were performed for the same (or similar) state. Hence, the adaptive rules optimization system effectively functions as a set of parallel optimization engines whereby each engine is automatically invoked based on state.

Moreover, the adaptive rules optimization system optimizes the sequencing of all trouble tickets that require manual attention. For a given state, the resolution of each trouble ticket has a cost and a benefit associated with it. The cost is defined as the time needed for resolution of the problem. The benefit is defined as the savings in Service level Agreement (SLA) penalties that would have been imposed if the problem was not resolved.

Accordingly, the adaptive rules optimization system is operative to compute which action would result in the highest benefit. All the alerts are then prioritized accordingly. Note that there may exist a variety of different solutions to this problem. One possible approach is to arrange all the tasks according to the FIFO principle (i.e. first in first out), as is well known in the art. It is appreciated that other strategies may be used with the present invention as well. For example, all the tasks can be arranged according to cost such that tasks with higher penalty values are handled before tasks with lower associated penalty values.

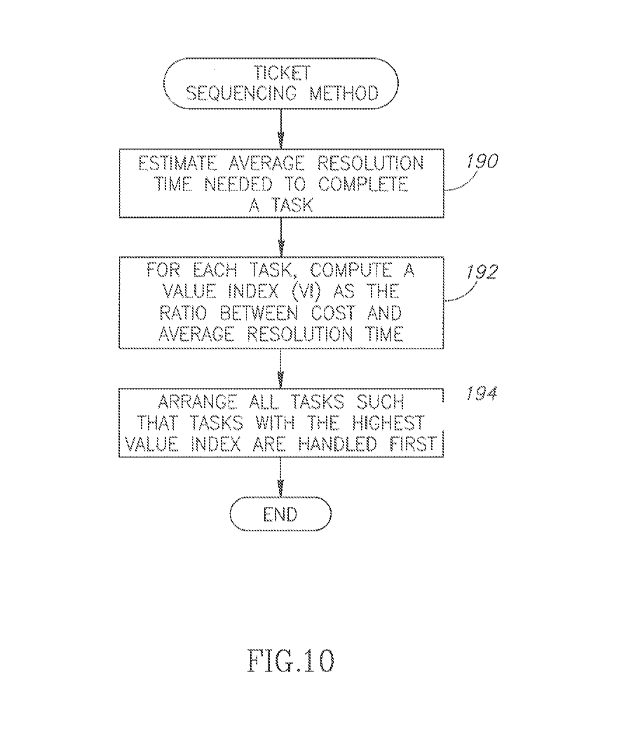

In a preferred embodiment, the following strategy is implemented. A flow diagram illustrating the ticket sequencing of the automatic trouble ticket queuing system of the present invention is shown in FIG. 10. First, the trouble ticket system is operative to automatically estimate the average resolution time (ART) needed to complete the particular task (step 190). Estimates of the average resolution time can be provided manually in advance. Alternatively, estimates of the average resolution time can be generated using an adaptive technique such that, for each trouble ticket (i.e. problem), the resolution time is measured. The average resolution time is then computed as a weighted average of the past resolution times.

For each task, a value index (VI) is computed as a ratio between the cost and average resolution time (step 192). All tasks are then arranged in order such that tasks having a higher value index (VI) are handled before tasks having a lower value index (step 194).

With reference to FIG. 3, in the production or operating mode, the operator (via the operator console 34) acts automatically, retrieves tickets from the ticket queue 32 according to assigned priorities, recognizes tickets types, carries out the appropriate actions for the particular ticket types and discards spurious events associated with the tickets.

With reference to FIG. 4, the post-processor analyzer 44 is used instead of the prioritization engine 36 (FIG. 3) in the off-line mode of operation. Thus, it uses historical operator logs for data instead of processing data output of the action log monitor 38 (FIG. 1).

Note that the invention is operative to learn of configuration changes dynamically. In the event the configuration of the system changes (e.g., a set of servers has been switched from one communication network to another), the prioritization engine 36 (FIG. 1) learns this fact automatically by logging changed patterns of alarms and through the adjusted reaction of the operator.

A block diagram illustrating the action log monitor portion of the automatic trouble ticket queuing system of the present invention in more detail is shown in FIG. 5. The action log monitor, generally referenced 50, comprises a ticket classifier 54, ticket correlator 56 and ticket type database 58. The action log monitor analyzes actions of the operator on received trouble tickets and functions to recognize possible ticket types.

In operation, tickets and actions 52 input to the system and/or generated by the operator are input to the ticket classifier which functions to classify the type of ticket, determine the features of spurious events and store the ticket type and spurious event features in the ticket log 74. The ticket correlator functions to correlate the extracted spurious event features with those of other trouble tickets received substantially around the same time.

The ticket type database 58 is adapted to store information related to the trouble tickets in ticket records 60. Each ticket record comprises the following fields: a ticket actions field 62, a priority associated with the ticket 64, a correlation set associated with each ticket 66, related alerts field 68, the average resolution time (ART) needed to resolve the trouble ticket 70 and a cost associated with resolving the trouble ticket.

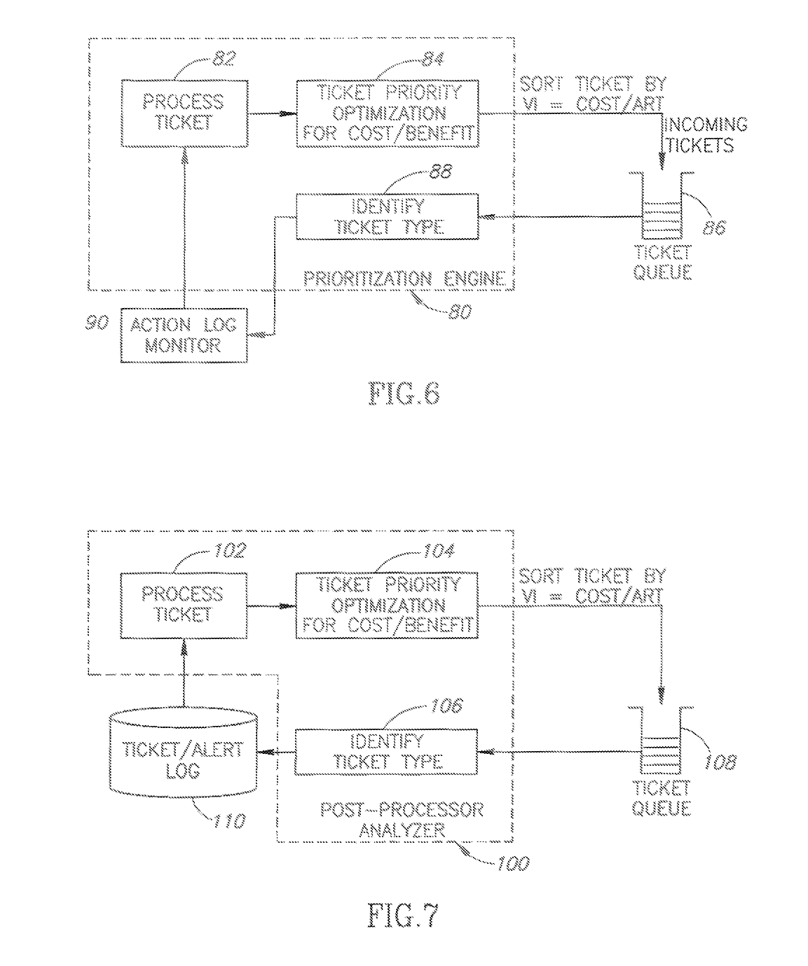

A block diagram illustrating the prioritization engine portion of the automatic trouble ticket queuing system of the present invention in more detail is shown in FIG. 6. The prioritization engine, generally referenced 80, comprises a ticket processor 82, ticket priority optimizer 84 and ticket type identifier 88. The prioritization engine functions to present the operator with relevant actions that can be performed on that particular type of ticket and optimizes the trouble tickets in the ticket queue based on priorities and service times.

In operation, ticket types of trouble tickets read from the ticket queue 86 are identified by block 88. The ticket types are input to the action log monitor and stored in the ticket log database 74 (FIG. 5). The types and action logged by the action log monitor 90 are input to the ticket processor 82. Each ticket is optimized for cost versus benefit by block 84 wherein the ratios of cost versus average resolution time for each ticket are compared to each other. The tickets are then sorted by value index and the ticket queue is configured accordingly.

A block diagram illustrating the post-process analyzer portion of the automatic trouble ticket queuing system of the present invention in more detail is shown in FIG. 7. The post-processor analyzer, generally referenced 100, comprises a ticket processor 102, ticket priority optimizer 104 and ticket type identifier 106. The post-process analyzer operates on historical trouble ticket data and alerts logs rather than with online ticket management systems.

The operation of the post-process analyzer is similar to that of the prioritization engine of FIG. 6. In operation, ticket types of trouble tickets read from the ticket queue 108 are identified by block 106. The ticket types are stored in the ticket/alert database 110. The types and action stored in the database are read out and processed by the ticket processor 102. Each ticket is optimized for cost versus benefit by block 104 wherein the ratios of cost versus average resolution time for each ticket are compared to each other. The tickets are then sorted by value index and the ticket queue is configured accordingly.

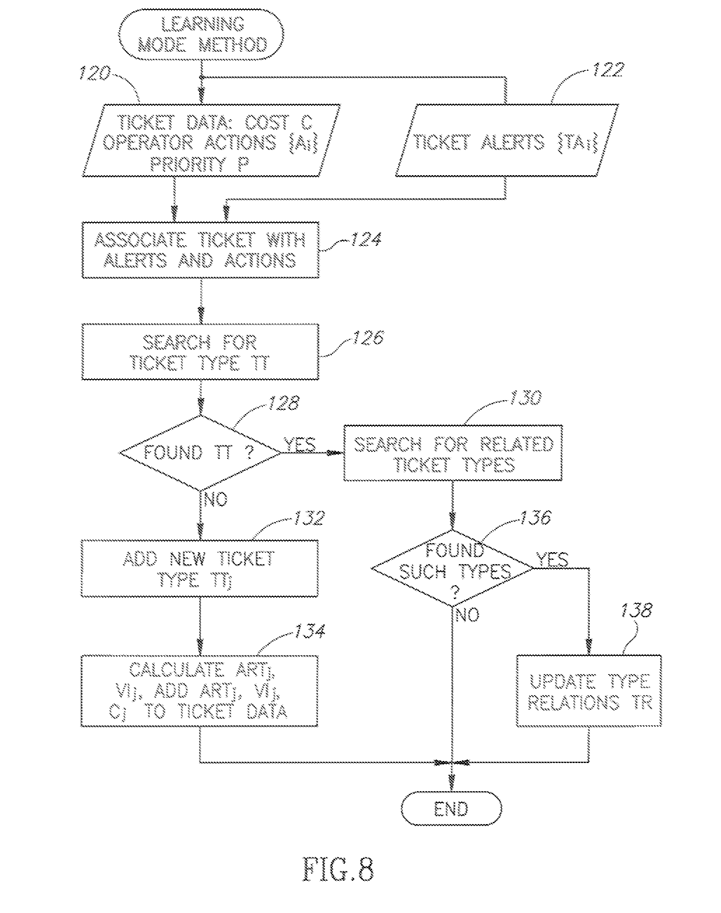

A flow diagram illustrating the learning mode of the automatic trouble ticket queuing system of the present invention is shown in FIG. 8. The algorithm takes as input ticket related data including: cost C, operator actions {Aᵢ} and priority P (step 120) and ticket alerts {TAᵢ} (step 122). Each trouble ticket is then associated with the input alerts and actions (step 124). A fuzzy search is performed for the ticket type (TT) (step 126). If the ticket type was found (step 128), a fuzzy search is performed for related ticket types (step 130). If the ticket types were found (step 136), the type relations (TR) are updated (step 138). Otherwise the method ends.

If the ticket type was not found (step 128), than a new ticket type TTⱼ is added (step 132). The average resolution time ARTⱼ and value index VIⱼ are then calculated and ARTⱼ, VIⱼ and Cⱼ are added to the ticket data (step 134).

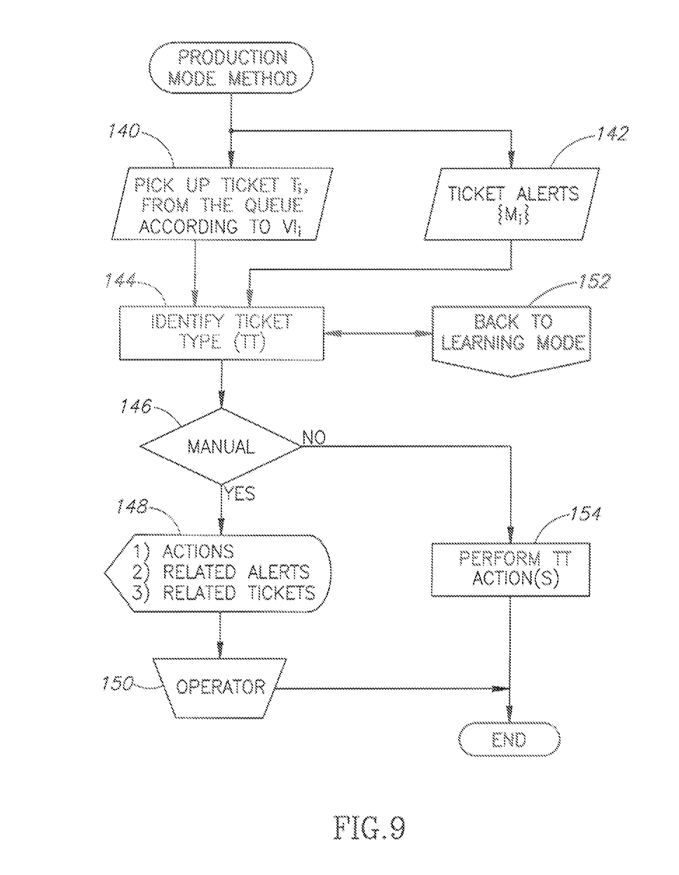

A flow diagram illustrating the production mode of the automatic trouble ticket queuing system of the present invention is shown in FIG. 9. In accordance with the method, the ticket Tᵢ is retrieved from the ticket queue in accordance with its value index (VIᵢ) (step 140). In addition, the ticket alerts {Mᵢ} are also input to the ticket identifier (step 142). The first step is to identify the ticket type (TT) of the retrieved trouble ticket and alerts (step 144). If the ticket type cannot be identified, the method returns to the learning mode method of FIG. 8. If the ticket type has associated automatic actions (step 146), the actions associated with the ticket type are then performed, such as by the operator console (step 154). If the ticket type has manual actions associated therewith (step 146), the particular corresponding actions, related alerts and related tickets are determined (step 148). This information is made available to the operator who then performs the actions (step 150).

Thus, in this manner, the present invention is operative to recognize and eliminate spurious events. The system identifies the features of spurious events by observing the actions of experts and learning from them. As an example, consider a communication line failure wherein as a result thereof 71 tickets were opened. These 71 tickets are made up of only a single ticket that points to the actual root problem and 70 others from entities which are dependant on the failed line (e.g., 10 servers and 50 applications). The expert (i.e. the operator) looks at these tickets and based on her/his past experience, decides the ticket related to the communication line must be resolved first. The operator makes an appropriate action (again based on experience) in order to resolve this problem. Once the problem is fixed, the operator closes all the tickets. The invention logs and analyzes (i.e. monitors) the expert decisions and actions and, in accordance with the invention, identifies the following:
1. there are 71 specific alerts (i.e. trouble tickets) that substantially occurred at the same time and are most likely connected to the same malfunction
2. the system operator prepares to handle the communication alert/trouble ticket first
3. the information that was used by the system operator
4. that closing the communication line ticket resulted in the closing of the other 70 trouble tickets

In this example, the invention generates the following based solely on the observation of expert actions: (1) an event correlation pattern (situation) with 1 main event and 70 spurious events which are related to the first one that occurred at substantially the same time (or a short time after the main event); and (2) a suggested outcome for this situation, namely to close the related 70 tickets, i.e. to act appropriately in response to 70 spurious events.

Note that the correlation performed by the invention is done adaptively, whereby the first time an expert makes a real action in order to resolve the first trouble ticket and closes the other 70 (or marks other 70 tickets as duplicates of the first ticket), and all 71 tickets have almost identical timestamps (e.g., within 1 minute or so of each other), the invention determines that there is a correlation between the first ticket and the 70 other tickets. The observation time, where all events/tickets occurs, can be automatically adjusted, if such a situation occurred in slightly different conditions, e.g., the network configuration did not changed but network latency is bigger this time that it was a previous time.

The fuzzy search is used to match the present event to one of the previous events. Continuing the example above, assume that the same communication line is down. We still have the communication line alert accompanied by alerts from all the servers that are connected through this communication line. In the interim, however, some servers may have been removed and new servers may have been added. The invention determines that all the alarms are correlated by analyzing their time stamps (as explained supra). The relevant past event, however, still needs to be determined. A fuzzy search is used to find the relevant past event. For example, an algorithm can be applied that states that relevant past events are defined as having 90% similarity to the present one (in comparison of all the alerts raised at roughly the same time).

Note also that the system continues learning during the operational mode. In the operational mode, the invention works either in automatic or semi-automatic mode. In automatic mode, the invention continues to learn from configuration changes when they occur. In semi-automatic mode, an expert (i.e. operator) will be presented with the list of suggested actions ranked by their priorities. in response, the operator can either: (1) change priorities; (2) add new actions to the list; or (3) correct suggested actions in order to further justify them.

Changes in configuration are learned as follows. With reference to the communication line failure example presented supra, the operator (i.e. expert) can decide to switch two servers and five critical applications to more reliable communication lines. This results in a single communication line trouble ticket followed by 63 spurious trouble tickets (i.e. 18 servers and 45 applications). In accordance with the invention, this action is logged. The situation of “one communication trouble ticket followed by 63 others” is compared with the similar situation of “one communication trouble ticket followed by 70 others” that were generated previously in the context of the expert “Configuration change” action.

The next occurrence of a single communication line failure, the system will use the new configuration (simply because it would provide a better match to the last event (i.e. 18 servers and 45 applications). The old configuration (i.e. 20 servers and 50 applications) would remain in the system. With the passage of time, however, it may be removed from the system by a simple “forgetting mechanism”. For example, the forgetting mechanism may be adapted to remove all the past events that were not repeated in the past one year period. In such a manner, the system learns the new configuration and forgets the old one.

In alternative embodiments, the methods of the present invention may be applicable to implementations of the invention in integrated circuits, field programmable gate arrays (FPGAs), chip sets or application specific integrated circuits (ASICs), DSP circuits, wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. An event correlation tool for use in a trouble ticket resolution system, said method comprising the steps of:
an action log monitor operative to classify tickets received in a ticket queue, log features of spurious events associated therewith and correlate said events with other tickets received at substantially the same time; and
a prioritization engine in communication with said action log monitor, said prioritization engine operative to assign priorities to said received tickets in accordance with previous operator action on said ticket queue.

2. The event correlation tool according to claim 1, further comprising a post-processing analyzer operative to use historical operator log information to assign priorities to tickets in said queue in an offline operation mode.

3. The event correlation tool according to claim 1, wherein said action log monitor comprises means for logging features of high priority tickets and all associated events that are removed once a particular ticket is closed by said operator.

4. The event correlation tool according to claim 1, wherein said prioritization engine assigns higher priority to tickets having a type chosen by said operator from among all tickets waiting in said queue.

5. The event correlation tool according to claim 1, wherein said prioritization engine is operative to re-compute priorities of all tickets remaining in said queue each time a ticket is closed.

6. The event correlation tool according to claim 1, wherein said prioritization engine comprises means for learning the spurious tickets to be filtered out in response a ticket being closed by said operator.

7. The event correlation tool according to claim 1, further comprising an automated operator console adapted to effect actions decided by said prioritization engine.

8. The event correlation tool according to claim 1, further comprising means for operating in a training mode wherein each ticket resolution is saved together with a set of alerts existing at the time of saving.

9. The event correlation tool according to claim 1, further comprising means for operating in an operating mode wherein existing state of alerts are compared to states encountered in the past.

10. The event correlation tool according to claim 9, further comprising means for performing a fuzzy search to determine the closest matching set of states is chosen.

11. The event correlation tool according to claim 1, wherein said action log monitor and said prioritization together effectively implement a plurality of parallel optimization engines, each invoked based on state.

12. The event correlation tool according to claim 1, wherein said preordination engine comprises means for optimizing the sequencing of tickets that require manual operator attention, and wherein each problem resolution has an associated cost and benefit.

13. The event correlation tool according to claim 12, wherein said means for optimizing comprises means for arranging all tasks in order of first-in first-out order, cost or by average resolution time needed for ticket completion followed by comparison of a value index.

14. A problem resolution system, comprising:
a ticket queue for receiving and holding trouble tickets;
an operator console adapted to permit an operator to interact with and perform action on tickets held in said ticket queue;
a ticket log for storing features of spurious events an actions taken on tickets in said queue;
an action log monitor in communication with said operator console and said ticket log, said action log monitor operative to classify tickets in said ticket queue, log features of spurious events associated therewith and correlate said events with other tickets received at substantially the same time; and
a prioritization engine in communication with said action log monitor and said ticket queue, said prioritization engine operative to assign priorities to tickets in said ticket queue in accordance with previous operator action on said ticket queue as captured by said action log monitor.

15. An event correlation method for use in a trouble ticket resolution system, said method comprising the steps of:
assigning a prioritization to tickets in a ticket queue in accordance with historical actions taken by an operator;
retrieving tickets from said queue in accordance with said assigned prioritizations;
recognizing a ticket type for each retrieved ticket;
performing an appropriate action for each particular ticket type; and
discarding spurious events associated with said particular ticket type.

16. An adaptive rules optimization method for use in a trouble ticket resolution tool adapted to store received trouble tickets in a ticket queue, said method comprising the steps of:
retrieving a ticket from said ticket queue;
saving a ticket resolution and a set of related alerts existing at that time in a ticket/alert database;
performing a fuzzy search on past alerts stored in said ticket/alert database to find a closest match with alerts associated with said retrieved ticket; and
directing said resolution tool to only consider those actions taken for the state corresponding to said closest matching set of alerts.
